(19) United States
(12) Patent Application Publication
(10) Pub. No.: US 2008/0274386 A1
(43) Pub. Date: Nov. 6, 2008

(54) Heat preservation container

(76) Inventor: Chih-Ching Hsieh, Taichung City (TW)

Correspondence Address: Chih-Ching Hsieh, 235 Chung-Ho, Box 8-24, Taipei, TW

(21) Appl. No.: 11/799,484

(22) Filed: May 2, 2007

(51) Int. Cl. H01M 8/04

(52) U.S. Cl. 429/26

(57) ABSTRACT

A heat preservation container comprises a container body having a receiving space; at least one fuel cell installed below the container body; and a heating element in an inner periphery of the receiving space; and wherein the fuel cell serves to actuate the heating element for heating the receiving space so as to retain the temperature of the receiving space. The fuel cell is placed in a cell casing. A switch is installed to the cell casing. The heating element is formed as plurality of heating wires. A cover serves for covering upon the container body.

### FIELD OF THE INVENTION

The present invention relates to heating containers, and particularly to a heat preservation container heated by at least one fuel cell without installing with a receptacle.

### BACKGROUND OF THE INVENTION

Currently, it is often that the food must be stored in a container for heat preservation so as to retain the fresh of the food.

The prior art heat preservation container must be connected to a power source for deriving power and thus a plug is installed. However in many places, it is inconvenient or impossible to approach a power source. Thus the heat preservation container is useless and the food therein can not retained with a desired temperature.

If the food is reheated again by a pot heated by fuel or electrically. It will result that the food cannot retain in fresh. Furthermore, it must be performed at a place installed with fuel source or electric source.

### SUMMARY OF THE INVENTION

Accordingly, the primary object of the present invention is to provide a heat preservation container heated by at least one fuel cell without installing with a receptacle.

To achieve above objects, the present invention provides a heat preservation container which comprises a container body having a receiving space; at least one fuel cell installed below the container body; and a heating element in an inner periphery of the receiving space; and wherein the fuel cell serves to actuate the heating element for heating the receiving space so as to retain the temperature of the receiving space. The fuel cell is placed. A switch is installed to the cell casing. The heating element is formed as plurality of heating wires. A cover serves for covering upon the container body.

The various objects and advantages of the present invention will be more readily understood from the following detailed description when read in conjunction with the appended drawing.

### BRIEF DESCRIPTION OF THE DRAWINGS

FIG. 1 is a schematic view of the heat preservation container of the present invention.

FIG. 2 is a partial schematic view of the heat preservation container of the present invention.

FIG. 3 is a perspective view of the heat preservation container of the present invention.

FIG. 4 is a schematic view showing the use of the heat preservation container of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

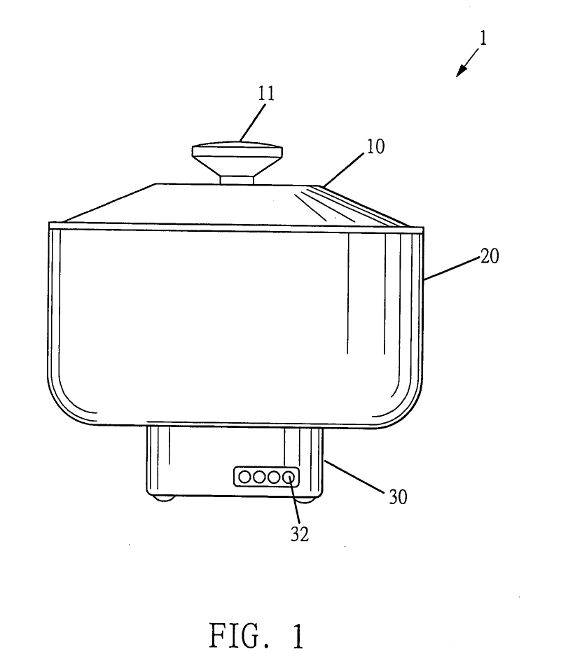

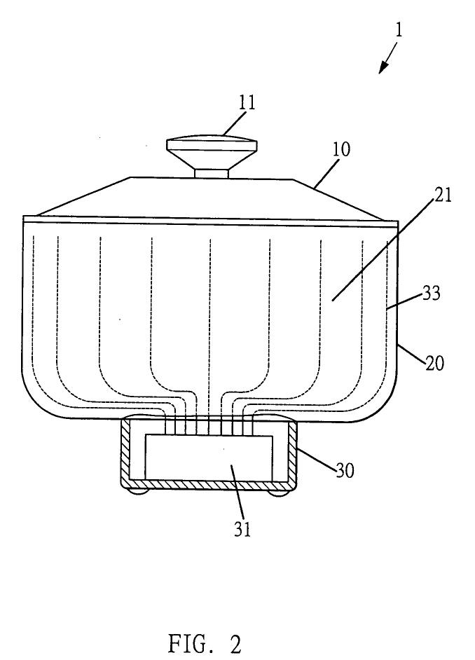

Referring to FIGS. 1 to 3, the fuel cell 31 of the present invention is illustrated. The present invention has the following elements.

A cover 10 has a holding portion 11 at an upper end thereof. The holding portion 11 is made of heat isolating material so that the user can hold the holding portion 11 safely.

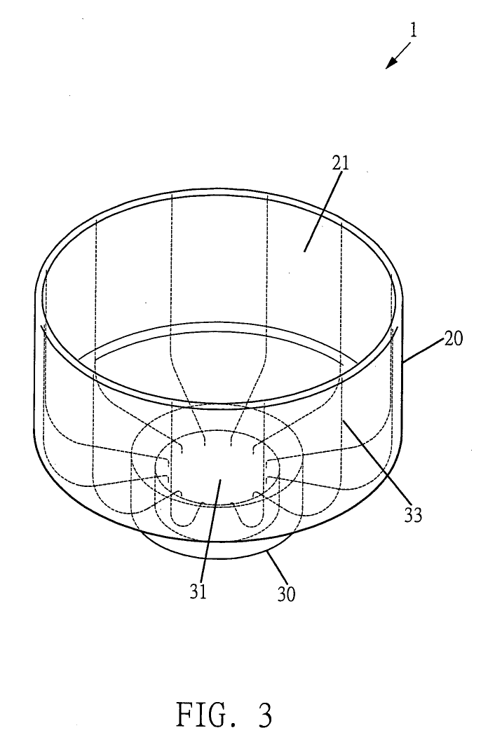

A container body 20 (referring to FIG. 3) is separated from the cover 10. The cover 10 can cover upon the container body 20. The container body 20 has a hollow receiving space 21 for receiving foods. The cover 10 serves to cover the receiving space 21 of the container body 20 so that the foods therein will not be polluted by flies or mosquitos.

A cell casing 30 is installed at a lower end of the container body 20. At least one fuel cell 31 is installed in the cell casing 30.

A heating unit is installed in the cell casing 30. The heating unit 35 is connected to the fuel cell 31. The cell casing 30 includes a switch 32 and a heating element 33. The switch 32 is installed in the cell casing 30 for actuating the heating unit 35 and for controlling the temperature retaining function. The heating element 33 is installed in an inner periphery of the container body 20. The heating element 33 is controlled by the switch 32 and is heated by the power from the fuel cell 31 so as to retain the temperature in the receiving space 21 of the container body 20.

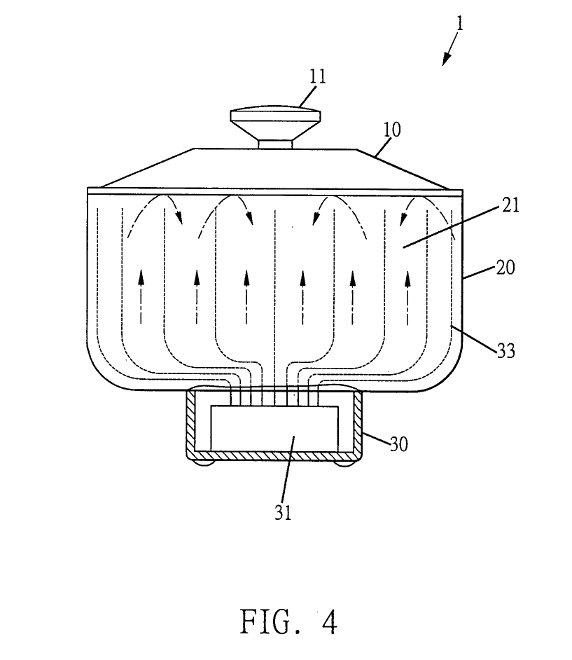

Referring to FIG. 4, the use of the present invention is illustrated. The switch 32 can be actuated by setting the temperature to be retained and the heating element 33 will generate heat by the power from the fuel cell 31 so as to heat the receiving space 21.

In the present invention, the heating element is formed as plurality of heating wires.

In use of the present invention, the fuel cell 31 installed to the cell casing 30 is used as a power source without needing to use an external plug. Thus the present invention can be used at necessary places and can be carried out easily and conveniently. The fuel cell 31 uses water as power source, which can be used repeatedly without the problem of environment pollution.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A heat preservation container comprising:
a container body having a receiving space;
at least one fuel cell installed below the container body; and
a heating element in an inner periphery of the receiving space;
wherein the fuel cell serves to actuate the heating element for heating the receiving space so as to retain temperature of the receiving space.

2. The heat preservation container as claimed in claim 1, wherein the fuel cell is placed in a cell casing and the cell casing is installed below the container body.

3. The heat preservation container as claimed in claim 2, wherein a switch is installed to the cell casing.

4. The heat preservation container as claimed in claim 1, wherein the heating element is formed as plurality of heating wires.

5. The heat preservation container as claimed in claim 1, further comprising a cover for covering upon the container body.
